(19) United States
(12) Patent Application Publication
(10) Pub. No.: US 2023/0145448 A1
(43) Pub. Date: May 11, 2023

(54) SYSTEMS AND METHODS FOR PREDICTING BUILDING FAULTS USING MACHINE LEARNING

(71) Applicant: Johnson Controls Tyco IP Holdings LLP, Milwaukee, WI (US)

(72) Inventors: Michael M. Huber, Old Westbury, NY (US); Gerald A. Asp, Milwaukee, WI (US); Daniel A. Mellenthin, Milwaukee, WI (US); Bao H. Ung, Milwaukee, WI (US)

(21) Appl. No.: 17/523,567

(22) Filed: Nov. 10, 2021

(51) Int. Cl. G05B 13/02; G06N 5/04

(52) U.S. Cl. CPC G05B 13/027; G06N 5/04

(57) ABSTRACT

A method for predicting time periods in which faults are likely to occur for a piece of building equipment. The method includes receiving a plurality of measurements for one or more points that are associated with a piece of building equipment, the plurality of measurements measured during a first time period; executing a machine learning model using the plurality of measurements as an input to generate fault data for a plurality of time periods subsequent to the first time period; selecting a second time period from the plurality of time periods responsive to an assessment of the fault data for the plurality of time periods indicating a fault will likely occur in the piece of building equipment during the second time period of the plurality of time periods; and performing an automated action responsive to the selection of the second time period.

### BACKGROUND

The present disclosure relates generally to building management systems (BMS), and more particularly to a building management system that can predict faults in building equipment using machine learning techniques.

Resolving faults in building equipment and determining the root causes of such faults has been a problem that has plagued the building management system industry for years. Often, building managers do not realize equipment in the buildings they manage is experiencing any issues until well after the issues begin and start to impact other faculties of the building. For example, a chiller of a building may experience a problem with its cooling system that may cause the chiller to blow out and for the temperature inside the building to increase to an uncomfortable level. A building management system monitoring aspects of the building may not identify any problems with the building until it determines the temperature has increased to an unacceptable level, and may then analyze the potential causes of the issue until the system determines the chiller has a defect in its cooling system. Upon identifying the problem, the system may attempt to resolve the issue. Even if the system manages to resolve the issue, it may take a substantial amount of time and result in the temperature remaining at uncomfortable levels for a prolonged period of time.

Moreover, building equipment faults may often impact how other pieces of building equipment of a building operate. For instance, if an air handling unit of a building breaks down, other air handling units of the building may operate to make up for the down air handling unit. This substitution often causes the operating building equipment to operate at capacity and/or at inefficient levels, thus increasing the energy costs incurred to keep the building at desired setpoints.

### SUMMARY

One implementation of the present disclosure is a method including receiving, by one or more processors, a plurality of measurements for one or more points that are associated with a piece of building equipment, the plurality of measurements measured during a first time period; executing, by the one or more processors, a machine learning model using the plurality of measurements as an input to generate fault data for a plurality of time periods subsequent to the first time period; selecting, by the one or more processors, a second time period from the plurality of time periods responsive to an assessment of the fault data for the plurality of time periods indicating a fault will likely occur in the piece of building equipment during the second time period of the plurality of time periods; and performing, by the one or more processors, an automated action responsive to the selection of the second time period.

In some embodiments, executing the machine learning model using the plurality of measurements further comprises: executing, by the one or more processors, the machine learning model using the plurality of measurements to obtain a plurality of confidence scores for the plurality of time periods; and wherein selecting the second time period from the plurality of time periods is performed responsive to determining that the second time period is associated with a confidence score that satisfies a predetermined criteria.

In some embodiments, determining the second time period is associated with a confidence score that satisfies a predetermined criteria comprises determining, by the one or more processors, that the confidence score exceeds a threshold.

In some embodiments, the machine learning model is a first machine learning model, and further comprising: responsive to the prediction indicating a fault will likely occur during the second time period, executing, by the one or more processors, a second machine learning model using the plurality of measurements to obtain an output indicating a predicted root cause of the predicted fault in the piece of building equipment; wherein performing the automated action comprises generating, by the one or more processors, a record comprising a recommendation for resolving the predicted fault based on the predicted root cause.

In some embodiments, executing the second machine learning model using the plurality of measurements further comprises executing, by the one or more processors, the second machine learning model using an identification of the second time period.

In some embodiments, the method includes presenting, by the one or more processors, the recommendation on a user interface; receiving, by the one or more processors via the user interface, an input indicating a level of accuracy of the recommendation; and training, by the one or more processors, the second machine learning model based on the predicted root cause and the input level of accuracy.

In some embodiments, executing the second machine learning model using the plurality of measurements to obtain the output indicating the root cause further comprises executing, by the one or more processors, the second machine learning model using the plurality of measurements to obtain a plurality of confidence scores for a plurality of root causes for the predicted fault, the method further comprising: presenting, by the one or more processors on a user interface, the plurality of confidence scores for the plurality of root causes; receiving, by the one or more processors via the user interface, a plurality of inputs indicating levels of accuracy of the plurality of confidence scores; and training, by the one or more processors, the second machine learning model based on the plurality of root causes and the plurality of inputs.

In some embodiments, the method includes storing, by the one or more processors, an association between the machine learning model and the piece of building equipment, wherein performing the automated action comprises: identifying, by the one or more processors, an identification of the piece of building equipment based on the stored association between the machine learning model and the piece of building equipment; and generating, by the one or more processors, a record comprising an identification of the piece of building equipment, and wherein performing the automated action comprises: identifying, by the one or more processors, an identification of the piece of building equipment based on the stored association between the machine learning model and the piece of building equipment; and generating, by the one or more processors, a record comprising an identification of the piece of building equipment.

In some embodiments, the method includes storing, by the one or more processors, an association between the machine learning and the piece of building equipment; retrieving, by the one or more processors, measurement data based on the stored association; and training, by the one or more processors, the machine learning model based on the retrieved measurement data.

In some embodiments, the method includes grouping, by the one or more processors, the plurality of measurements into a plurality of time bins based on timestamps associated with the plurality of measurements, each time bin of the plurality of time bins associated with a different time window; and generating, by the one or more processors, a feature vector using the grouped plurality of measurements by labeling the plurality of measurements with labels identifying the time bins into which each of the plurality of measurements has been grouped, wherein executing the machine learning model using the plurality of measurements further comprises applying, by the one or more processors, the feature vector as an input into the machine learning model.

In some embodiments, grouping the plurality of measurements into the plurality of time bins further comprises: grouping, by the one or more processors, measurements of individual time bins of the plurality of time bins into a plurality of sub-time bins; and determining, by the one or more processors, averages of measurements of individual sub-time bins of the plurality of sub-time bins, wherein generating the feature vector using the received measurements further comprises generating, by the one or more processors, the feature vector using the determined averages and labeling, by the one or more processors, the determined averages with labels identifying the individual sub-time bins of the determined averages.

In some embodiments, the method includes identifying, by the one or more processors, one or more setpoints for the one or more points, the one or more setpoints configured for times within the first time period; wherein executing the machine learning model using the plurality of measurements further comprises executing, by the one or more processors, the machine learning model using the one or more setpoints, and wherein executing the machine learning model using the plurality of measurements further comprises executing, by the one or more processors, the machine learning model using the one or more setpoints.

Another implementation of the present disclosure is a system comprising one or more memory devices configured to store instructions thereon that, when executed by one or more processors, cause the one or more processors to receive a plurality of measurements for one or more points that are associated with a piece of building equipment, the plurality of measurements measured during a first time period; execute a machine learning model using the plurality of measurements as an input to generate fault data for a plurality of time periods subsequent to the first time period; select a second time period from the plurality of time periods responsive to an assessment of the fault data for the plurality of time periods indicating a fault will likely occur in the piece of building equipment during the second time period of the plurality of time periods; and perform an automated action responsive to the selection of the second time period.

In some embodiments, the instructions cause the one or more processors to execute the machine learning model using the plurality of measurements further by causing the one or more processors to: execute the machine learning model using the plurality of measurements to obtain a plurality of confidence scores for the plurality of time periods; and select the second time period from the plurality of time periods responsive to determining the second time period is associated with a confidence score that satisfies a predetermined criteria.

In some embodiments, the instructions cause the one or more processors to determine the second time period is associated with a confidence score that satisfies a predetermined criteria by causing the one or more processors to determine that the confidence score exceeds a threshold.

In some embodiments, the machine learning model is a first machine learning model, and the instructions further cause the one or more processors to: responsive to the prediction indicating a fault will likely occur during the second time period, execute a second machine learning model using the plurality of measurements to obtain an output indicating a predicted root cause of the predicted fault in the piece of building equipment; wherein the instructions cause the one or more processors to perform the automated action by causing the one or more processors to generate a record comprising a recommendation for resolving the predicted fault based on the predicted root cause.

In some embodiments, the instructions cause the one or more processors to execute the second machine learning model using the plurality of measurements by causing the one or more processors to execute the second machine learning model using an identification of the second time period.

In some embodiments, the instructions further cause the one or more processors to: present the recommendation on a user interface; receive, via the user interface, an input indicating a level of accuracy of the recommendation; and train the second machine learning model based on the predicted root cause and the input level of accuracy.

Another implementation of the present disclosure is a method including receiving, by one or more processors, a plurality of measurements for one or more points that are associated with a piece of building equipment, the plurality of measurements measured during a first time period; executing, by the one or more processors, a first machine learning model using the plurality of measurements to obtain an output predicting a fault will occur in the piece of building equipment within a second time period subsequent to the first time period; responsive to the prediction that a fault will occur in the piece of building equipment within the second time period, executing, by the one or more processors, a second machine learning model using the plurality of measurements and an identification of the second time period to obtain an output indicating a predicted root cause of the predicted fault in the piece of building equipment; and performing, by the one or more processors, an automated action responsive to the predicted root cause of the predicted fault in the piece of building equipment.

In some embodiments, performing the automated action comprises generating, by the one or more processors, a record comprising a recommendation for resolving the predicted fault based on the predicted root cause, further comprising: presenting, by the one or more processors, the recommendation on a user interface; receiving, by the one or more processors via the user interface, an input indicating a level of accuracy of the recommendation; and training, by the one or more processors, the second machine learning model based on the predicted root cause and the input level of accuracy.

### BRIEF DESCRIPTION OF THE DRAWINGS

FIG. 1 is a perspective view of a smart building, according to some embodiments.

FIG. 2 is a block diagram of a waterside system, according to some embodiments.

FIG. 3 is a block diagram of an airside system, according to some embodiments.

FIG. 4 is a block diagram of a building management system, according to some embodiments.

FIG. 5 is a block diagram of a smart building environment, according to some embodiments.

FIG. 6 is a block diagram of a system including a fault prediction system, according to some embodiments.

FIG. 7 is a flow diagram of a process for predicting a time period in which a fault is likely to occur using machine learning, according to some embodiments.

FIG. 8 is a flow diagram of a process for training a machine learning model to predict a time period in which a fault is likely to occur, according to some embodiments.

FIG. 9 is a flow diagram of a process for training a machine learning model to predict a root cause of a predicted fault, according to some embodiments.

FIG. 10 is a flow diagram of another process for predicting a time period in which a fault is likely to occur using machine learning, according to some embodiments.

FIG. 11 is a block diagram illustrating a process for organizing raw data values into time bins, according to some embodiments.

FIG. 12 is an illustration of data values organized into multiple time bins, according to some embodiments.

FIG. 13 is a block diagram illustrating a process for training a neural network, according to some embodiments.

FIG. 14 is a block diagram illustrating a neural network predicting a time period in which a fault will likely occur, according to some embodiments.

FIG. 15 is a user interface depicting root cause predictions for faults, according to some embodiments.

FIG. 16 is another user interface depicting root cause predictions for faults, according to some embodiments.

### DETAILED DESCRIPTION

### Overview

Referring generally to the figures, systems and methods for predicting time periods in which faults are likely to occur are disclosed herein. Over time, it is common for pieces of building equipment to experience wear that can result in the equipment experiencing faults and malfunctioning. Often, building managers do not realize their equipment is experiencing any issues or faults until well after the issues begin and the issues start to impact how other pieces of building equipment within the same building operate. A building manager may desire to avoid faults in building equipment altogether to maintain a comfortable environment for a building's occupants and to avoid the excess electrical consumption that often accompanies such faults.

By implementing the systems and methods described herein, a system may resolve the aforementioned technical deficiencies by automatically predicting whether a fault will occur in a piece of building equipment using measurement data for points of the building equipment. The system may generate a feature vector using the measurement data and input the feature vector into a machine learning model that has been trained to predict time periods in which a fault is likely to occur in the equipment. Based on a predicted time period, the system may perform an automated action (e.g., display the predicted time period, generate and transmit a record comprising information about the fault to an external computing device, adjust the configuration of the building equipment based on the predicted time, etc.). The automated action may enable the system or a user to take action to resolve the predicted fault before it occurs. Thus, by implementing the systems and methods described herein, the system may enable equipment to maintain operation, increasing building equipment electricity usage efficiency while maintaining the comfortability of the building. Further, because the equipment can continue operating as normal, the system can avoid causing further faults in other building equipment that may result from the building equipment operating at or above capacity to account for any equipment that is experiencing downtime.

Moreover, by implementing the systems and methods described herein, the system may automatically predict the root cause of a predicted fault. For instance, after the system determines a piece of building equipment is likely to experience a fault within a particular time period, the system may execute another machine learning model using the measurement data that the system used to predict the fault to predict a root cause for the predicted fault. Further, because the root cause of faults may correspond to the times in which they are predicted to occur (e.g., the length of the time into the future the faults are predicted to occur), the system may also use an identification of the time period in which the fault is predicted to occur as an input into the machine learning model to obtain a more accurate indication of a predicted root cause. Thus, the system may implement a cascading machine learning model system to predict when a fault is likely to occur and the root cause of the fault.

### Building and HVAC Systems

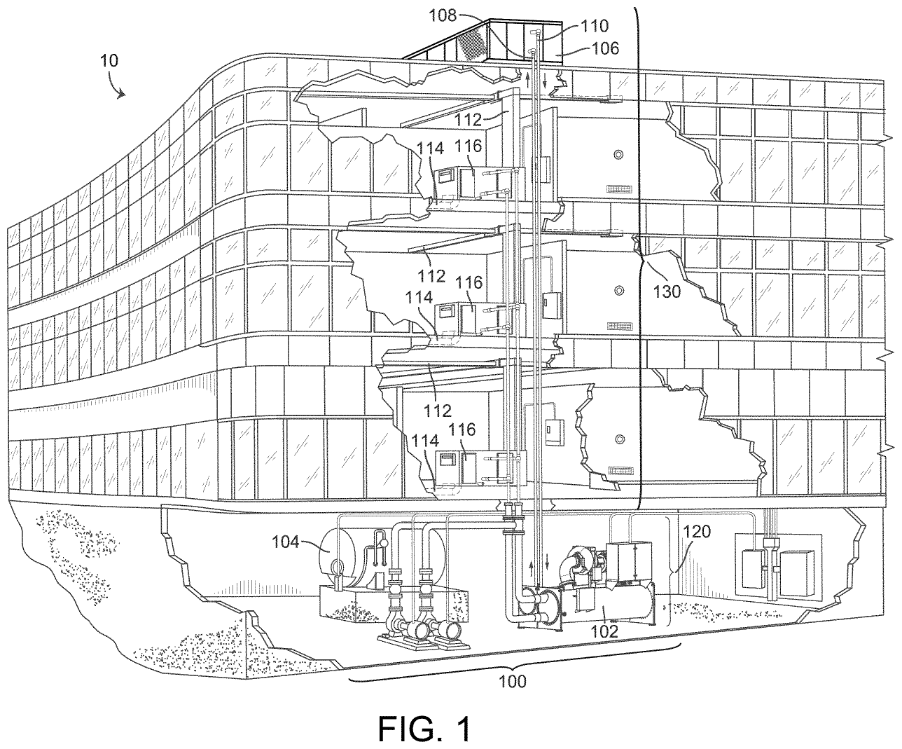

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, an HVAC system, a security system, a lighting system, a fire alerting system, any other system that is capable of managing building functions or devices, or any combination thereof.

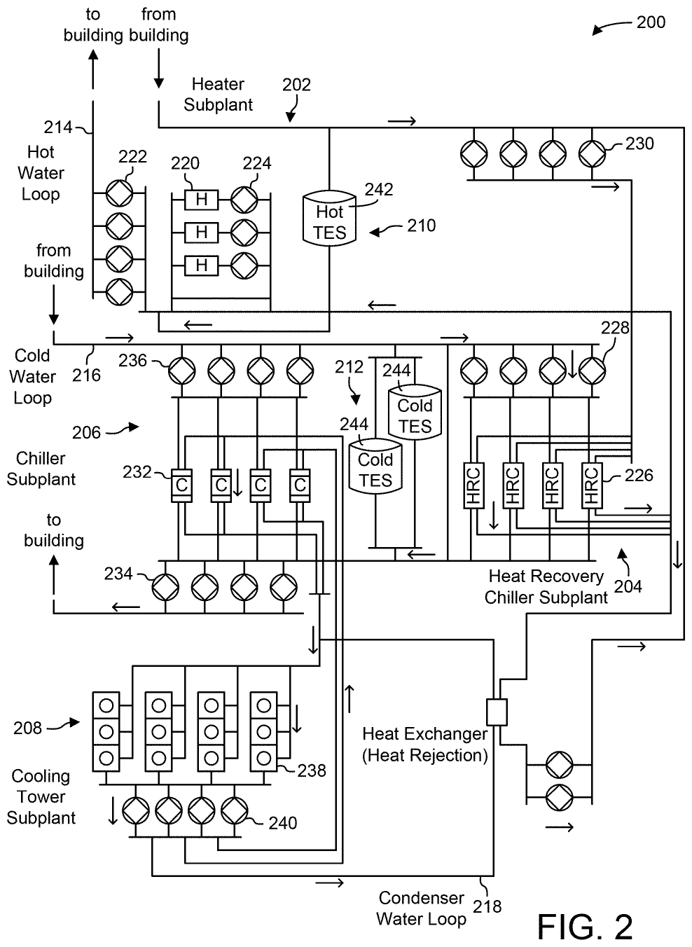

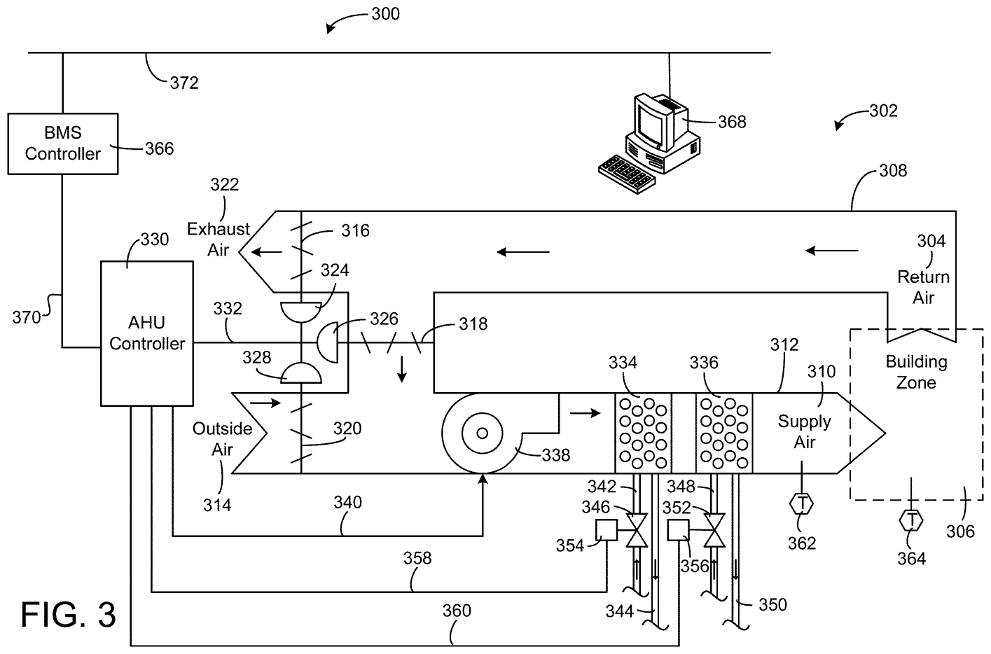

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

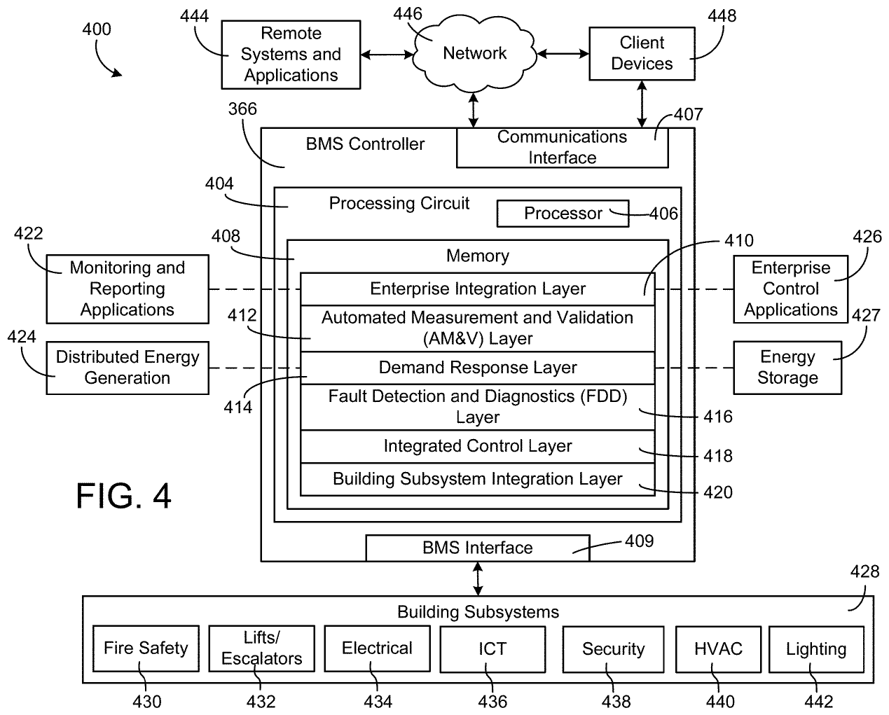

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In some embodiments, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine control actions for building subsystems 428 based on the inputs, generate control signals based on the determined control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which reduce energy costs based on one or more inputs representative of or based on demand (e.g., price, a curtailment signal, a demand level, etc.). In some embodiments, demand response layer 414 uses equipment models to determine a set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

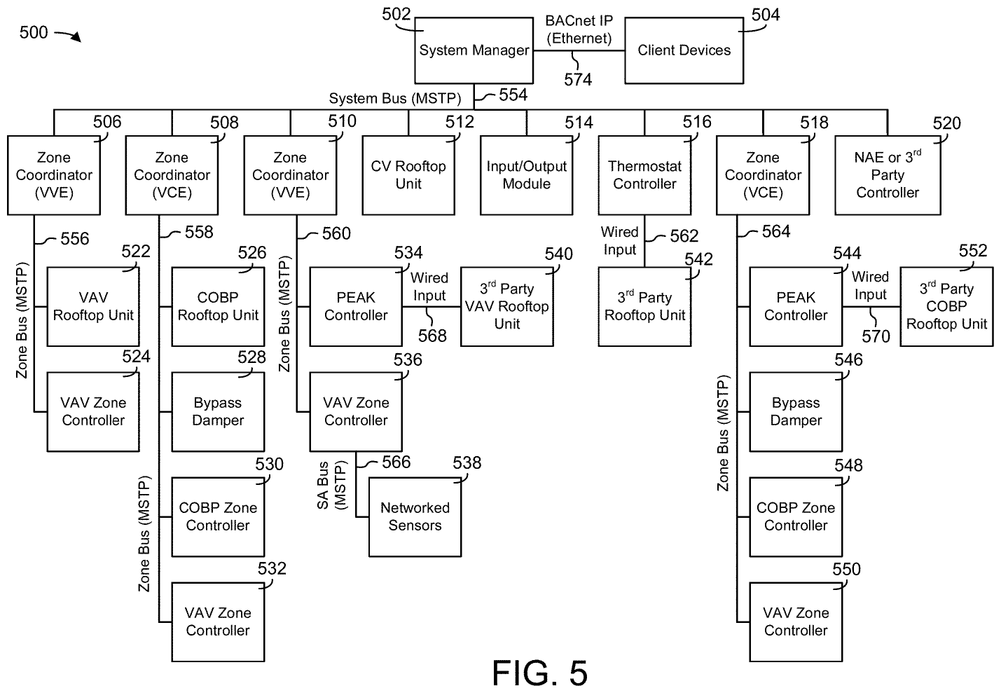

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Fault Prediction System

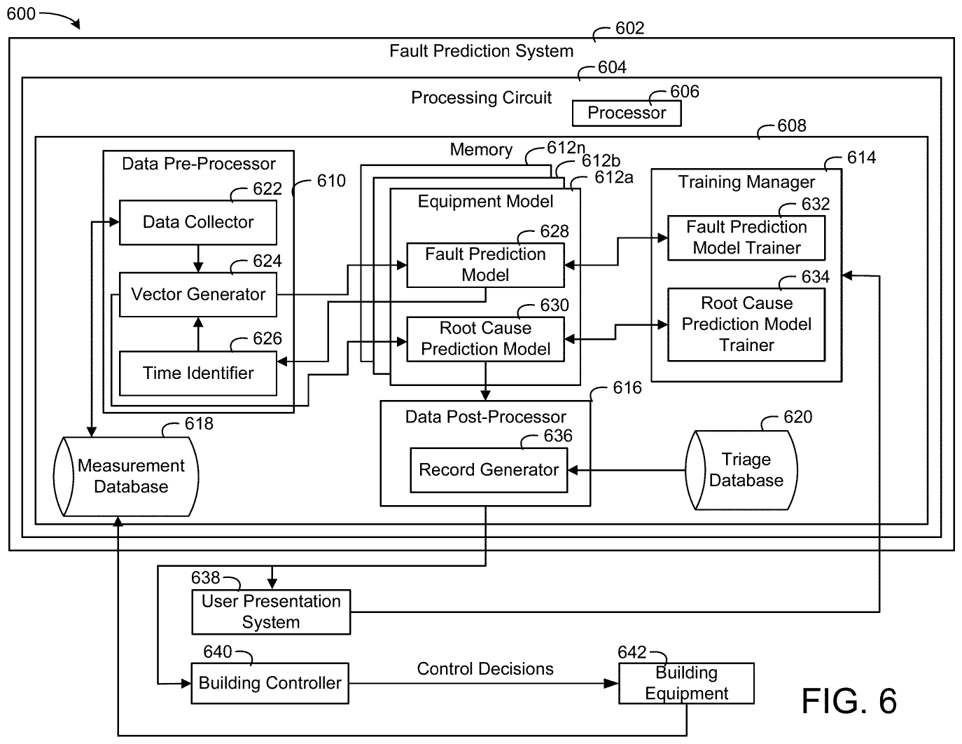

Referring now to FIG. 6, a block diagram of a system 600 including a fault prediction system 602 that is configured to predict time periods in which a fault is likely to occur for a piece of building equipment in a building management system (e.g., BMS 400 or 500) is shown, according to an exemplary embodiment. Fault prediction system 602 may operate in a cloud environment or locally by a processor at the building management system. Fault prediction system 602 may implement one or more machine learning models to predict time periods in which a fault is likely to occur in a piece of building equipment and a root cause of such faults. Fault prediction system 602 may do so by inputting measurements of various points of the piece of building equipment into the machine learning models and determining whether individual output confidence scores for time periods and/or root causes from the models satisfy a predetermined criteria (e.g., exceed a predetermined threshold, is the highest predicted confidence score, etc.). Additionally, fault prediction system 602 may use a predicted root cause to identify different methods of resolving the predicted fault before the fault occurs, thus potentially causing the equipment to continue operating correctly and efficiently without experiencing any faults.

As used herein, “points” or “data points” refer to sensor inputs, control outputs, control values, and/or different characteristics of the inputs and/or outputs. “Points” and/or “data points” may refer to various data objects relating to the inputs and the outputs such as BACnet objects. The objects may represent and/or include a point and/or group of points. The object may include various properties for each of the points. For example, an analog input may be a particular point represented by an object with one or more properties describing the analog input and another property describing the sampling rate of the analog input. For example, in some embodiments, a point is a data representation associated with a component of a BMS, such as a camera, thermostat, controller, VAV box, RTU, valve, damper, chiller, boiler, AHU, supply fan, etc.

System 600 may include a user presentation system 638, a building controller 640, and building equipment 642. Building controller 640 may be similar to or the same as BMS controller 366. Fault prediction system 602 may be a component of or be within building controller 640. In some embodiments, fault prediction system 602 operates in the cloud as one or more cloud servers. Components 602 and 638-642 may communicate over a network (e.g., a synchronous or asynchronous network).

Fault prediction system 602 may include a processing circuit 604, a processor 606, and a memory 608. Processing circuit 604, processor 606, and/or memory 608 can be the same as, or similar to, processing circuit 404, processor 406, and/or memory 408, as described with reference to FIG. 4. Memory 608 may include a data pre-processor 610, equipment models 612a-n, a training manager 614, a data post-processor 616, a measurement database 618, and a triage database 620. Memory 608 may include any number of components.

Data pre-processor 610 includes instructions performed by one or more servers or processors (e.g., processing circuit 604), in some embodiments. In some embodiments, data pre-processor 610 includes a data collector 622, a vector generator 624, and a time identifier 626. Data collector 622 may be configured to collect data that corresponds to different pieces of building equipment (e.g., building equipment 642). Data collector 622 can be configured to retrieve and/or collect building data from a building management system and store the building data in measurement database 618, in some embodiments. Data collector 622 can be configured to collect data automatically or, in some embodiments, poll sensors associated with building equipment 642 to collect data at predetermined time intervals set by an administrator. In some embodiments, data collector 622 can further be configured to collect data upon detecting that a value changed by an amount exceeding a threshold. In some embodiments, data collector 622 is configured to collect building data upon receiving a request from an administrator. The administrator may make the request from a client device. The administrator can request building data associated with any time period and building device.

Data collector 622 may be configured to tag each data point of the data with timestamps indicating when the data point was generated and/or when data collector 622 collected the data point from the sensors. In some embodiments, data collector 622 can also tag the data with a device identifier tag indicating the building device from which the building data was collected. Thus, data collector 622 may store the timestamped data in measurement database 618 as a timeseries corresponding to how the measured values changed over time.

As described herein, timeseries can be a collection of values for a particular point (e.g., a discharge air temperature point of an air handling unit, a discharge air temperature, a supply fan status, a zone air temperature, a humidity, a pressure, etc.) generated at different times (e.g., at periodic intervals). The values may include or be associated with identifiers of the building devices with which the points are associated (e.g., an air handler, a VAV box, a controller, a chiller, a boiler, vents, dampers, etc.). Each timeseries can include a series of values for the same point and a timestamp for each of the data values. For example, a timeseries for a point provided by a temperature sensor (e.g., provided through local gateways) can include a series of temperature values measured by the temperature sensor and the corresponding times at which the temperature values were measured. An example of a timeseries which can be generated by data collector 622 is as follows:

[<key, timestamp₁, value₁>, <key, timestamp₂, value₂>, <key, timestamp₃, value₃>]

where key is an identifier of the source of the raw data samples (e.g., timeseries ID, sensor ID, device ID, etc.), timestampi may identify the time at which the ith sample was collected, and valuei may indicate the value of the ith sample.

Measurement database 618 may be a database configured to store building data associated with a building management system (e.g., BMS 400). Measurement database 618 can be a graph database, MySQL, Oracle, Microsoft SQL, PostgreSql, DB2, document store, search engine, device identifier-value store, etc. Measurement database 618 can be configured to hold data including any amount of values and can be made up of any number of components. The data can include various measurements and states (e.g., temperature readings, pressure readings, device state readings, blade speeds, etc.) associated with building equipment (e.g., AHUs, chillers, boilers, VAVs, fans, etc.) of the building management system. In some embodiments, the building data is tagged with timestamps indicating times and dates that the values of the building data were generated by devices (e.g., sensors) of the building management system or retrieved by data collector 622.

In some embodiments, measurement database 618 may store setpoint values for different points of the building management system. The stored setpoint values may be associated with a schedule indicating the times in which building equipment 642 will operate so points of the building managements system will reach the corresponding stored setpoints. For example, a setpoint schedule may indicate that a kitchen should be 70 degrees at 7 P.M. but 68 degrees at 3 P.M. Accordingly, a controller (e.g., building controller 640) may control the building equipment of the building to cause the temperature point to reach the setpoint temperature at the corresponding times. Measurement database 618 may include schedules for setpoints of any point of the building to reach a desired level of comfort for the building's occupants.

Vector generator 624 may be configured to generate a feature vector that is configured to be input into machine learning models of equipment models 612a-n from measurement database 618. Vector generator 624 may generate such feature vectors upon determining an event has occurred. An event may be or include a detection that a value associated with the piece of building equipment is above a threshold, a determination that a predetermined time interval has passed since vector generator 624 previously executed the machine learning model, receipt of a user input indicating to execute the machine learning model, receipt of a signal from another computing device indicating to execute the machine learning model, etc. Vector generator 624 may monitor various aspects of the building management system to identify such events and determine when the events occur. For example, vector generator 624 may keep track of the times in which vector generator 624 executes the machine learning model. Vector generator 624 may maintain an internal clock and identify when a predetermined (e.g., a pre-programmed) time period has passed since the last time vector generator 624 executed the machine learning model and determine the predetermined time period has passed. Vector generator 624 may identify an event as occurring upon determining the predetermined time period has passed.

Upon determining an event has occurred, vector generator 624 may generate a feature vector. Vector generator 624 may generate the feature vector by identifying the piece of building equipment that is associated with the event (e.g., the piece of building equipment that has a stored association with the event) and retrieve data that corresponds to the piece of building equipment. Vector generator 624 may retrieve the data that is associated with attributes or points of the piece of building equipment based on a stored association between the values and the attributes or points. Vector generator 624 may retrieve data that is associated with values from within a pre-configured time frame of the event (e.g., values that are associated with timestamps from a time frame before and/or after the event) and generate a feature vector using the retrieved values. Vector generator 624 may retrieve values that were collected from sensors of the building and/or values of setpoints that are stored in memory (e.g., measurement database 618).

Upon generating the feature vector, vector generator 624 may identify the machine learning model that is associated with the piece of building equipment that is associated with the event. Vector generator 624 may identify the machine learning model from equipment models 612a-n that each includes or is otherwise associated with a different fault prediction model 628 and/or a root cause prediction model 630. Each of equipment models 612a-n may be a data representation of a different piece of building equipment within the building management system. The fault prediction models and/or root cause prediction models of each equipment model 612a-n may be associated with a device identifier of the respective equipment model 612a-n. Vector generator 624 may identify fault prediction model 628 responsive to determining the identified event and fault prediction model 628 are associated with the same or an identical device identifier. Upon identifying fault prediction model 628, vector generator 624 may apply the generated feature vector to fault prediction model 628 and execute fault prediction model 628.

Fault prediction model 628 may be a machine learning model (e.g., a neural network, a random forest, a support vector machine, etc.) configured to output time periods and/or confidence scores associated with time periods in which a fault is likely to occur in a piece of building equipment. Fault prediction model 628 may be configured to output confidence scores for one or more time periods based on feature vectors that are generated by vector generator 624 based on data that corresponds to a particular piece of building equipment (e.g., the piece of building equipment that the equipment model represents). Fault prediction model 628 may output confidence scores for one or more time periods of any size into the future indicating likelihoods that a fault will occur in the piece of building equipment within each time period. Time identifier 626 may identify the confidence scores and/or determine if and when a fault is likely to occur in the piece of building equipment in the future based on the confidence scores.

Time identifier 626 may be configured to use a predetermined criteria to determine if and/or when a fault is likely to occur in a piece of building equipment. The predetermined criteria may be a threshold and/or one or more rules. For instance, time identifier 626 may determine a fault is likely to occur during the predicted time period by comparing the confidence score to a predetermined threshold. Responsive to determining the score exceeds the threshold, time identifier 626 may determine a fault is likely to occur during the time period. However, responsive to determining the score does not exceed the threshold, the data processing system may determine a fault is not likely to occur during the time period. The data processing system may compare the confidence score to any rule or threshold.

Upon determining a confidence score for a time period satisfied the predetermined criteria, time identifier 626 may identify the time period associated with the confidence score and an identification of the time period. In some embodiments, time identifier 626 may generate an alert indicating a fault is likely to occur in the piece of building equipment during the identified time period and transmit the alert to a client device (e.g., an administrative device) so an administrator can view the alert and take action to stop the predicted fault from occurring. In some embodiments, time identifier 626 may feed the identification of the time period back to vector generator 624, which in turn can use the identification to generate a new feature vector to determine the root cause of the predicted fault.

Responsive to time identifier 626 determining a fault is likely to occur in a piece of building equipment, vector generator 624 may generate a new feature vector using the same measurements that were used to generate the first feature vector. In some embodiments, vector generator 624 may also include the identification of the time period in which the fault is predicted to occur in the feature vector. Vector generator 624 may identify root cause prediction model 630 based on root cause prediction model 630 being associated with the same piece of building equipment as fault prediction model 628 (e.g., based on root cause prediction model 630 being associated with the same or an identical equipment identifier) and input the new feature vector into root cause prediction model 630 to execute root cause prediction model 630 to predict a root cause of the predicted fault.

Root cause prediction model 630 may be a machine learning model similar to fault prediction model 628 that is configured to predict potential root causes of faults that are predicted to occur by fault prediction model 628. Root cause prediction model 630 may be configured to output confidence scores for one or more root causes based on feature vectors that are generated by vector generator 624 based on data that corresponds to a particular piece of building equipment (e.g., the piece of building equipment that the equipment model represents) and, in some embodiments, an identification of a time period predicted by fault prediction model 628. Fault prediction model 628 may output confidence scores for one or more root causes indicating likelihoods that the individual root causes are the correct prediction. Data post-processor 616 may receive the output confidence scores and process the scores to transmit a signal to user presentation system 638 and/or building controller 640 to resolve the predicted fault based on the predicted root cause.

Data post-processor 616 includes instructions performed by one or more servers or processors (e.g., processing circuit 604), in some embodiments. In some embodiments, data post-processor 616 includes a record generator 636. Record generator 636 may receive the predicted confidence scores and generate a record (e.g., a file, document, table, listing, message, notification, etc.) including confidence scores and/or the root causes. In some embodiments, record generator 636 may compare the confidence scores to a predetermined criteria to determine a root cause of the predicted fault similar to how time identifier 626 determined the time period in which the fault is predicted to occur (e.g., compare the confidence scores to a threshold and/or identify the highest confidence score). In such embodiments, record generator 636 may only include the root causes that are associated with confidence scores that satisfy the predetermined criteria in the generated record. Upon generating the record, record generator 636 may transmit the record to user presentation system 638 for display and/or building controller 640 to use to adjust operation or the configuration of building equipment 642 to avoid the predicted fault.

In some embodiments, record generator 636 may generate records for the predicted faults and/or root causes to include recommendations for resolving the faults. To do so, record generator 636 may retrieve recommendations for predicted root causes (e.g., root causes with a confidence score above a threshold, a root cause associated with a confidence score that satisfies a predetermined criteria, or each possible root cause for which root cause prediction model 630 is configured to predict a confidence score) from triage database 620. Record generator 636 may retrieve the recommendations to resolve the root causes and generate records including the recommendations to send to user presentation system 638 and/or building controller 640.

Triage database 620 may be a database configured to store building data associated with a building management system (e.g., BMS 400). Triage database 620 can be a graph database, MySQL, Oracle, Microsoft SQL, PostgreSql, DB2, document store, search engine, device identifier-value store, etc. Triage database 620 can be configured to hold data including recommendations to resolve various faults based on the predicted root causes. Triage database 620 may be or include recommendations that are associated with identifiers that correspond to various root causes. Record generator 636 may identify root causes as described above and match the root causes with the recommendations stored in triage database 620. Record generator 636 may identify recommendations that match the predicted root causes and include the recommendations in the records that record generator 636 generates for various faults.

Fault prediction system 602 can provide indications of time periods in which a fault will occur and/or recommendations to resolve such faults to user presentation system 638 and/or building controller 640. In some embodiments, building controller 640 uses the expected recommendations to operate building equipment 642 (e.g., control environmental conditions of a building, cause generators to turn on or off, charge or discharge batteries, etc.). Further, user presentation system 638 can receive the indications and/or recommendations and cause a client device to display indications (e.g., graphical elements, charts, words, numbers, etc.) of the time period and/or recommendations. For example, user presentation system 638 may receive a time period in which a fault is predicted to occur and/or recommendations to resolve or stop such faults from occurring and display the received data at a client device.

In some embodiments, fault prediction system 602 trains the prediction models of equipment models 612a-n using training manager 614. Training manager 614 includes instructions performed by one or more servers or processors (e.g., processing circuit 604), in some embodiments. In some embodiments, training manager 614 includes a fault prediction model trainer 632 and/or a root cause prediction model trainer 634. Fault prediction model trainer 632 may be configured to train fault prediction model 628 and other fault prediction models of equipment models 612a-n to predict time periods in which faults are likely to occur for pieces of building equipment. Fault prediction model trainer 632 may feed labeled training data including measurements associated with points of a particular piece of building equipment to the fault prediction model associated with the piece of building equipment. The respective fault prediction model may output confidence scores for various time periods and fault prediction model trainer 632 may determine differences between the predicted outputs and the labels and use back-propagation techniques according to a loss function to adjust the fault prediction model's weights and parameters proportional to the determined differences. Fault prediction model trainer 632 may repeat these steps for any number of fault prediction machine learning models to train the machine learning models to predict future faults for individual pieces of building equipment.

Similarly, root cause prediction model trainer 634 may be configured to train root cause prediction model 630 and other root cause prediction models of equipment models 612a-n. Root cause prediction model trainer 634 may feed measurement data and/or identifications of time periods into a root cause prediction model to obtain confidence scores for root causes of a potential fault in a piece of building equipment. Root cause prediction model trainer 634 may identify labels indicating the correct output, determine differences between the correct output and the respective root cause prediction model's output, and use back-propagation techniques according to a loss function to adjust the root cause prediction model's weights and parameters according to the determined differences. Root cause prediction model trainer 634 may repeat these steps for any number of root cause prediction models to the machine learning models to predict root causes of predicted faults for individual pieces of building equipment.

In some embodiments, root cause prediction model trainer 634 may train a root cause prediction model in real-time. In such embodiments, root cause prediction model trainer 634 may feed measurement data and/or identifications of time periods into a root cause prediction model to obtain confidence scores for root causes of a potential fault in a piece of building equipment. Record generator 636 may display potential root causes, the confidence scores, and/or recommendations associated with the potential root causes on a user interface of user presentation system 638 as described above. A user may input levels of accuracy (e.g., correct, incorrect, partially correct, etc.) of the recommendations and/or the predicted root causes. Root cause prediction model trainer 634 may identify the input levels of accuracy, determine differences between the predicted confidence scores and the input levels of accuracy, and use back-propagation techniques with the root cause prediction model that predicted the confidence scores for the root causes according to a loss function based on the differences. Thus, root cause prediction model trainer 634 may train root cause prediction models in real-time, which may be advantageous in situations in which labeled training data is not easily available or the corresponding piece of building equipment is experiencing wear that may impact the model's predictions.

In some embodiments, training manager 614 may operate in a cloud server and be configured to use training data from multiple building management systems to train fault prediction models and/or root cause prediction models. Training manager 614 may be configured to train individual machine learning models using training data that is associated with multiple pieces of building equipment (e.g., building equipment of the same type) until the machine learning models are accurate to a threshold, and then deploy the machine learning models to the local building management system to be used to make predictions for individual pieces of building equipment (and be further trained based only on data associated with the piece of building equipment). This may be advantageous in building management systems that do not have enough training data to train machine learning models to make accurate predictions.

In such embodiments, training manager 614 may be configured to train the machine learning models using a weighting policy. The weight policy may include weights that can be applied to different training data sets. The weights may correspond to different building management systems and may be determined based on how trustworthy an administrator has determined data from a building management system to be and/or based on whether the data originated at a building management system for which the models are being trained. Training manager 614 may use the weights by weighting the differences in a loss function so that training data that is associated with higher weights cause higher shifts in the weights or parameters of a machine learning model than training data that is associated with lower weights during training. Thus, training manager 614 may control the training to improve the accuracy and speed with which machine learning models are trained to be employed at individual building management systems.

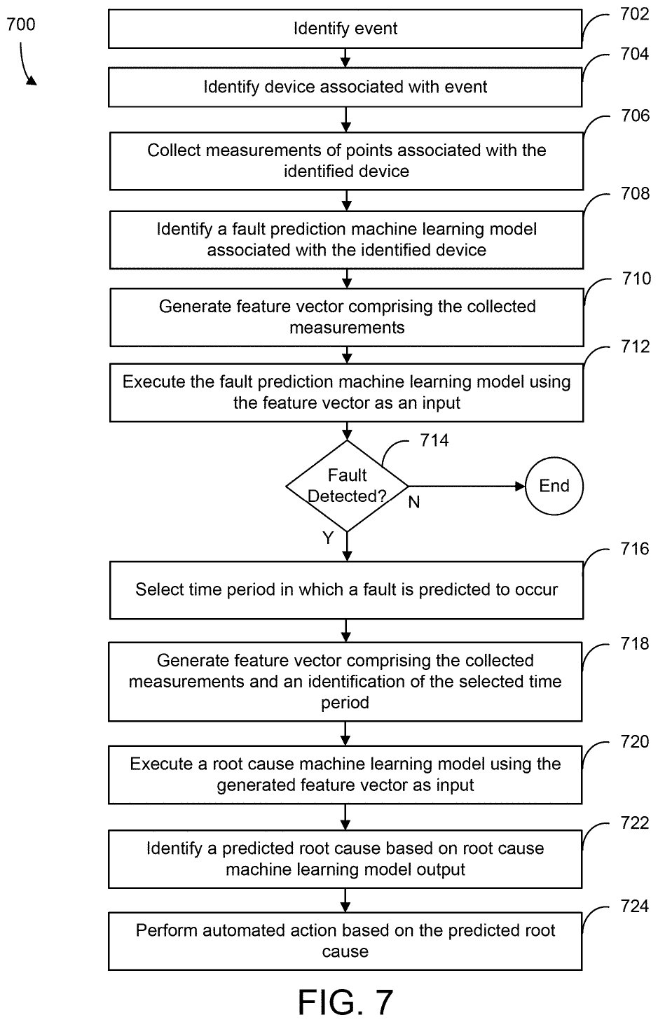

Referring now to FIG. 7, a flow diagram of a process 700 for predicting a time period in which a fault is likely to occur using machine learning is shown, according to some embodiments. Process 700 may be performed by a data processing system (e.g., fault prediction system 602). Process 700 may include any number of steps and the steps may be performed in any order. In some embodiments, the data processing system may perform process 700 by executing a fault prediction machine learning model that has been trained based on data specific to a particular piece of building equipment to ensure the fault prediction machine learning model can accurately predict a fault for the piece of building equipment.

At a step 702, the data processing system may identify an event. The event may indicate to execute a machine learning model to predict if and/or when a fault will occur in a particular piece of building equipment. An event may be or include a detection that a value associated with the piece of building equipment is above a threshold, a determination that a predetermined time interval has passed since the data processing system previously executed the fault prediction machine learning model, receipt of a user input indicating to execute the fault prediction machine learning model, receipt of a signal from another computing device indicating to execute the fault prediction machine learning model, etc. The data processing system may monitor various aspects of the building management system to identify such events and determine when the events occur. For example, the data processing system may keep track of the times in which the data processing system executes the fault prediction machine learning model. The data processing system may maintain an internal clock and identify when a predetermined (e.g., a pre-programmed) time period has passed since the last time the data processing system executed the fault prediction machine learning model and determine the predetermined time period has passed.

In another example, the data processing system may monitor a particular point of a building that is associated with the piece of building equipment. For instance, the data processing system may detect when the temperature inside the building increases above a threshold and detect an event as occurring responsive to the determination. The data processing system may identify events based on any setpoints or any predetermined criteria.

At a step 704, the data processing system may identify the piece of building equipment associated with the event. For example, responsive to receiving a user input indicating to determine if and/or when a fault will occur in a piece of building equipment, the data processing system may identify the piece of building equipment based on the input, such as based on an identification of the building equipment included in the input. In another example, responsive to determining a point of a building is above a threshold or meets another criteria that causes the data processing system to determine an event occurred, the data processing system may identify the piece of building equipment that is associated with the point based on a correlation between the point and the piece of building equipment that is stored in memory.

At a step 706, the data processing system may collect measurements of points associated with the identified piece of building equipment. The measurements may be measurements of points of the building that correspond to the piece of building equipment and preconfigured measurements associated with the piece of building equipment. For example, if the piece of building equipment is a chiller that is configured to provide air-conditioning for a room, the data processing system may collect measurements, the inside air temperature of the room, the indoor humidity of the room, light that is entering the room, and/or any other point of the building management system that may be impacted by how the chiller operates. In some embodiments, the data processing system may additionally or instead collect data of points that may impact how the chiller operates such as outside air temperature, outside humidity, occupancy, etc. The data processing system may also collect pre-configured setpoints for the piece of building equipment such as an inside air temperature setpoint, a humidity setpoint, or any other setpoint for the room or space (or other rooms or spaces that are affected by the piece of building equipment's operation). Such setpoint data may be useful for a comparison between how the affected area currently is operating and how it is configured to be operating.

After identifying an event that is associated with the piece of building equipment, the data processing system may collect measurements associated with the piece of building equipment from memory. The measurements may be measurements that the data processing system previously collected from sensors that are configured to detect measurements for points for the building. For example, responsive to identifying an event associated with a piece of building equipment, the data processing system may identify measurements from memory based on their stored association with points of the piece of building equipment (e.g., based on their associations with attributes of the piece of building equipment). The data processing system may identify and collect measurements that are within a time period of the time in which the data processing system identifies the event. The data processing system may identify such measurements based on timestamps associated with the measurements (e.g., the data processing system may identify measurements that are associated with timestamps that are within a predetermined time period of the event) that indicate when the measurements were generated or collected.

Further, in some embodiments, the data processing system may collect the pre-configured setpoints for the piece of building equipment after identifying the event. The data processing system may collect the pre-configured setpoints by identifying the setpoints that are set for points of the building that the piece of building equipment can impact. The data processing system may store associations (e.g., attributes of the piece of building equipment) between the setpoints and the piece of building equipment in memory, and the data processing system may retrieve the setpoints based on the stored associations. For example, responsive to identifying the event and the piece of building equipment, the data processing system may identify the setpoints that are associated with the piece of building equipment and retrieve the setpoints from memory. Such setpoints may be pre-configured setpoints (e.g., target environmental values such as temperature and humidity) and may change over time (e.g., change according to a pre-established schedule or according to a manual user input such as a user overriding a temperature setpoint with an input to a thermostat.). The data processing system may collect the setpoints by identifying values for the setpoints during a time within a time period before and/or after identifying the event. The data processing system may do so based on timestamps of the setpoints.

At a step 708, the data processing system may identify the fault prediction machine learning model associated with the identified piece of building equipment. The fault prediction machine learning model may be any machine learning model (e.g., a neural network, random forest, a support vector machine, etc.) and may be configured to predict time periods in which a fault is likely to occur in the piece of building equipment. The fault prediction machine learning model may have been trained based on training data that solely included fault data (e.g., instances in which a fault occurred) for the specific piece of building equipment so the fault prediction machine learning model can more accurately predict faults for the piece of building equipment and is not incorrectly biased based on training data generated based on faults in other pieces of building equipment or building equipment of different types. Further, the model may be continuously trained over time to ensure the model can adjust to any wear the piece of building equipment experiences during operation. The data processing system may identify the fault prediction machine learning model based on a model-equipment identifier pair that may be stored in the memory of the data processing system (e.g., the data processing system may identify the model using the equipment identifier as a look-up). The data processing system may identify the fault prediction machine learning model and execute the model using the collected measurements associated with the piece of building equipment.

At a step 710, the data processing system may generate a feature vector comprising the collected measurements (e.g., the collected data from the sensors and the collected setpoints). The data processing system may gather the collected data and generate a feature vector with the collected data by assigning the collected data to index values of the feature vector that correspond to the type of the data. For example, the data processing system may assign an inside air temperature setpoint value to a third index value and a measured inside air temperature value to a fifth index value of the feature vector based on each value's respective data type. The data processing system may assign values to the feature vector based on any data type. In some embodiments, before assigning the values to the feature vector, the data processing system may normalize the values to values between zero and one or between negative one and positive one. Any normalization technique may be used to change the values. Such normalization may improve the accuracy of the fault prediction machine learning model's output.

In some embodiments, the data processing system may generate the feature vector by grouping the plurality of measurements into time bins. The data processing system may identify the collected measurements (e.g., the collected measurements from the sensors and/or the collected measurements from memory) based on timestamps associated with each of the measurements. The data processing system may identify values with timestamps that are within a particular range of each other (e.g., five minutes, an hour, two hours, a day, a week, etc.) and assign labels to the values to indicate the time bins that correspond to the ranges of each of the timestamps. The data processing system may assign the measurements to time bins that correspond to any ranges. The data processing system may assign the values to the time bins and generate a feature vector based on the assigned time bins by including labels for the values that correspond to the assigned time bins in the feature vector and/or by setting the values to index values that are associated with the respective time bins.

In some embodiments, the data processing system may repeat the binning process and further group the collected data into further sub-time bins or time segments. The time bins may be grouped into smaller segments based on the data falling into smaller time periods within the time bins (e.g., if the time period includes data associated with a particular day, a sub-time bin may include data associated with an hour during the day). Each time bin may include any number of sub-time bins. The data processing system may group the time bins into the sub-time bins and label the data based on the grouped sub-time bins instead of or in addition to the labels for the larger time bins and generate the feature vector based on the sub-groupings.

In some embodiments, the data processing system may group the data into sub-time bins by calculating an average of the values within the respective sub-time bin. The data processing system may identify the values within the sub-time bin and calculate an average of each of the identified values. The data processing system may label the averages with labels indicating the sub-time bin and/or the time bin that is associated with the average. The data processing system may generate a feature vector using the averages as values instead of the individual values of the sub-time bins or in addition to such values.

At a step 712, the data processing system may execute the identified machine learning model using the feature vector as an input. The data processing system may execute the fault prediction machine learning model and obtain an output including a confidence score indicating a likelihood that a fault will occur in the piece of building equipment within a time period in the future (e.g., an hour into the future, a day into the future, five days into the future, etc.). The time period may be a time period of any size or length.

The data processing system may compare the confidence score for the time period to a predetermined criteria to determine whether a fault is likely to occur during the time period. The predetermined criteria may be a threshold or one or more rules. For instance, the data processing system may determine a fault is likely to occur during the predicted time period by comparing the confidence score to a predetermined threshold. Responsive to determining the score exceeds the threshold, the data processing system may determine a fault is likely to occur during the time period. However, responsive to determining the score does not exceed the threshold, the data processing system may determine a fault is not likely to occur during the time period. The data processing system may compare the confidence score to any rule or threshold.

In some embodiments, the fault prediction machine learning model may be configured to output confidence scores for a plurality of time periods upon processing the feature vector. The time periods may be any length and may or may not overlap with each other. The data processing system may retrieve the output confidence scores and compare the confidence scores to the predetermined criteria to determine whether any of the confidence scores satisfy the predetermined criteria. For instance, the data processing system may compare the confidence scores with each other and identify the highest confidence score. The data processing system can compare the highest confidence score to a threshold to determine if a fault is likely to occur during the time period associated with the confidence score. The data processing system may determine a fault is not likely to occur with the piece of building equipment responsive to determining the confidence score does not exceed the threshold or determine a fault will occur during the time period responsive to the confidence score exceeding the threshold.

In some embodiments, the data processing system may compare each or a portion of the confidence scores to the threshold. The data processing system may identify any confidence scores that exceed the threshold as being associated with a time period in which a fault is likely to occur. If the data processing system identifies multiple confidence scores that exceed the threshold, the data processing system may determine a fault will likely occur during each of the time periods associated with such confidence scores or determine an accurate prediction could not be made and transmit an alert to a computing device (e.g., user presentation system 638) indicating the data processing system could not make a prediction, depending on the configuration of the data processing system.

Responsive to determining a fault is not likely to occur, the data processing system may generate and transmit an alert to a computing device indicating a fault is not likely to occur or otherwise stop performing process 700. However, responsive to determining a fault is likely to occur during a particular time period, at a step 716, the data processing system may select an identification of the time period in which the fault is likely to occur. The data processing system may generate an alert indicating a fault will likely occur during the time period and transmit the alert to a computing device or perform another automated action, such as changing the configuration of the piece of building equipment predicted to experience a fault or of other pieces of building equipment.

At a step 718, the data processing system may generate a feature vector comprising the collected measurements and, in some embodiments, an identification of the selected time period. The data processing system may generate the feature vector using the same collected measurements (e.g., collected measured values and setpoints) for points of the piece of building that were used to predict a fault in the piece of building equipment. The data processing system may assign the collected measurements to index values of the feature vector based on the types of the measurements (e.g., a humidity value may be assigned to one particular index value of the feature vector and an indoor air temperature value may be assigned to another index value). In some embodiments, the collected values may be grouped into time bins or sub-time bins similar to the manner described above.

Additionally, in some embodiments, the data processing system may include an identification of the time period or time periods in which the fault or faults are predicted to occur in the feature vector. For example, if the fault prediction machine learning model predicts a fault will occur three to four hours into the future the data processing system may generate the feature vector to include an identification of the time period. The identification may be an arbitrary numerical value or it may otherwise correspond to the specific one-hour time period (e.g., the identification may be “three” or a value between three and four). The data processing system may include multiple identifications in the feature vector if faults are predicted to occur over multiple time periods (e.g., an identification for each of the time periods) or one identification that indicates the multiple time periods. By including the identification of the time period, the feature vector may be used to more accurately predict a root cause of the predicted fault because the times in which the faults are predicted to occur may correspond to different issues the building equipment device is experiencing.

At a step 720, the data processing system may execute a machine learning model configured to predict the root causes of faults (e.g., a root cause prediction machine learning model) using the generated feature vector as input. The root cause machine learning model may be any machine learning model (e.g., a neural network, a support vector machine, random forest, a clustering model, etc.) configured to predict a root cause for the predicted fault. The data processing system may apply the feature vector into the root cause machine learning model to execute the root cause machine learning model.

In some embodiments, the data processing system may store root cause machine learning models to predict root causes of faults for particular types of building equipment. For example, one root cause machine learning model may be configured or trained to predict root causes of predicted faults for an AHU and another root cause machine learning model may be configured to predict the root cause of predicted faults for a boiler. By doing so, the fault prediction machine learning models may be able to predict causes of faults that are more specific to the individual pieces of building equipment (e.g., a fan is not turning) rather than just general root causes (e.g., a component of the equipment is not functioning correctly). In such cases, upon determining a fault will occur in a piece of building equipment, the data processing system may identify the type of the piece of building equipment that is expected to experience the fault and execute a root cause machine learning model that is trained to predict the root causes of faults for the identified type to obtain a predicted root cause for the predicted fault.

In some embodiments, the data processing system may store root cause machine learning models for specific pieces of building equipment (e.g., each root cause machine learning model may be trained by data specific a particular piece of building equipment). For example, if a building has more than one AHU, the data processing system may store a machine learning model for each individual AHU. By doing so, the root cause machine learning models may be trained based on the operation of the individual AHUs and may account for different levels of wear of each AHU. Thus, the root cause machine learning models may be trained to make more accurate predictions for their corresponding piece of building equipment than machine learning models that are trained to make predictions for a type of building equipment. In such cases, upon determining a fault will occur in a piece of building equipment, the data processing system may identify the piece of building equipment that is expected to experience the fault and execute a root cause machine learning model trained to predict the root cause of predicted faults for the identified piece of building equipment to obtain a predicted root cause.

Executing a root cause machine learning model may cause the machine learning model to output one or more confidence scores for different possible root causes of the predicted faults. For example, if a fault is predicted to occur for an AHU, the root cause machine learning model may be configured to predict confidence scores for different root causes of faults that can occur in the AHU, such as no control strategy implemented, overrides/out of service/unreliability, zone use is over design capacity, sensor not calibrated and/or working properly, and/or cannot deliver required fresh air in the zone. The root cause machine learning model may predict confidence scores for any number of root causes for faults.

The data processing system may retrieve the output confidence scores for the possible root causes and compare the confidence scores to predetermined criteria to determine whether any of the confidence scores satisfy the predetermined criteria. For instance, the data processing system may compare the confidence scores with each other and identify the highest confidence score. The data processing system can compare the highest confidence score to a threshold to determine whether the model predicted the root cause with enough confidence to indicate the prediction was accurate. Because the threshold may be configurable, an operator may control the necessary level of confidence in a predicted root cause before the data processing system predicts the root causes of faults.

At an operation 724, the data processing system may identify the predicted root cause of the fault based on the root cause machine learning model output. As described above, the data processing system may compare the output confidence scores of the root cause machine learning model to predetermined criteria. The data processing system may determine which, if any, confidence scores satisfies the criteria and identify the root cause that is associated with the confidence score that satisfies the criteria.

At an operation 726, the data processing system may perform an automated action based on the predicted root cause and/or the predicted fault. The automated action may be an action that may be performed by the data processing system such as adjusting a piece of building equipment (e.g., if an AHU is predicted to experience a fault because it is overheating, the data processing system may adjust the AHU to use less energy and, in some cases, cause other AHUs operating in the same building to use more energy), displaying the predicted root causes on a user interface (e.g., the data processing system may generate and transmit records of the predicted root causes of faults or just indications of the faults themselves to a user device, in some cases with their corresponding confidence scores, for display), and/or generating a record with instructions indicating how to resolve the root causes of the faults. Each of these actions may enable the system or an operator to act to resolve the fault before it occurs to stop any energy efficiencies or problems with other pieces of building equipment that may occur if the fault were to occur in the piece of building equipment.

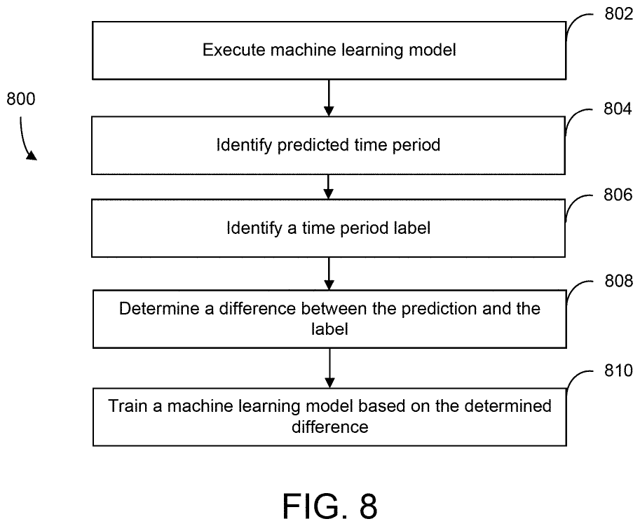

Referring now to FIG. 8, a flow diagram of a process 800 for training a machine learning model to predict a time period in which a fault is likely to occur is shown, according to some embodiments. Process 800 may be performed by a data processing system (e.g., fault prediction system 602). Process 800 may include any number of steps and the steps may be performed in any order. The data processing system may perform process 800 after executing a machine learning model using a feature vector with collected measurement values to obtain a predicted confidence score for a particular time period predicting when a fault is likely to occur in a piece of building equipment. The data processing system may perform process 800 by executing a fault prediction machine learning model that has been trained based on data specific to a particular piece of building equipment. By doing so, the data processing system may ensure the fault prediction machine learning model can more accurately predict a fault for the piece of building equipment compared to machine learning models that may have been trained based on training data from other pieces of building equipment or standard rule-based approaches.

At a step 802, the data processing system may execute a machine learning model using a set of collected measurements in a feature vector to obtain an output predicted time period. The data processing system may execute the fault prediction machine learning model as described above. Upon execution, the fault prediction machine learning model may output confidence scores for one or more time periods indicating levels of confidence the fault prediction machine learning model has that a fault will occur in a particular piece of building equipment during the respective time periods.

At a step 804, the data processing system may identify a predicted time period in which a fault is likely to occur in the piece of building equipment. The data processing system may identify the predicted time period and/or a confidence score associated with the predicted time period from the output of the fault prediction machine learning model. In some embodiments, the fault prediction machine learning model may predict confidence scores for multiple time periods. In such embodiments, the data processing system may identify the confidence scores associated with each of the time periods.

At a step 806, the data processing system may identify a time period label that corresponds to the set of collected measurements. The time period labels may represent a ground truth for the correct confidence scores or the correct and/or incorrect predictions for the time periods for which the fault prediction machine learning model is configured to make predictions. The time period labels may be confidence scores ranging from 0 to 100, 0 to 1, or may be within any other range, or may be binary values of 0 or 1 indicating whether the time bin is the correct prediction for the set of collected measurements. The data processing system may identify the time period labels from the generated feature vector and/or from memory (e.g., a user may input the labels to be stored in memory and the data processing system may retrieve the input labels from memory).

At a step 808, the data processing system may determine a difference between the prediction and the labels. The data processing system may compare the confidence scores for each of the time periods and determine differences between the prediction and the labels based on the comparison. At a step 810, the data processing system may train the fault prediction machine learning model based on the determined differences using a loss function. For instance, the data processing system may determine the differences and use back-propagation techniques to feed the differences back into the fault prediction machine learning model to adjust the model's internal weights and parameters proportional to the differences. The data processing system may repeat process 800 using any number of training data sets to train the fault prediction machine learning model to predict times in which faults are likely to occur.

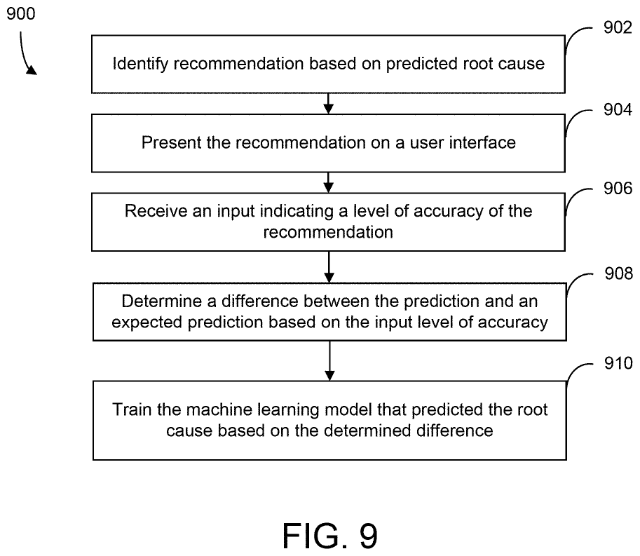

Referring now to FIG. 9, a flow diagram of a process 900 for training a machine learning model to predict root causes of predicted faults is shown, according to some embodiments. Process 900 may be performed by a data processing system (e.g., fault prediction system 602). Process 900 may include any number of steps and the steps may be performed in any order. The data processing system may perform process 900 by executing a machine learning model that has been trained based on data specific to a particular piece of building equipment. As a result of such training, the root cause machine learning model may more accurately predict root causes for the piece of building equipment compared to machine learning models that may have been trained based on training data from other pieces of building equipment or standard rule-based approaches.

At a step 902, the data processing system may identify a recommendation based on a predicted root cause of a fault. The recommendation may be a recommendation to resolve the predicted root cause of the fault. The data processing system may identify the recommendation after a fault prediction machine learning model predicts a fault will occur and a root cause machine learning model predicts possible root causes for the predicted fault. The root cause machine learning model may predict confidence scores for multiple root causes and display the confidence scores adjacent to identifiers of the root causes on a user interface of a client device.

Each potential root cause may be associated with one or more recommendations for resolving the associated potential root cause. Examples of such recommendations may include equipment undersized, valve undersized, coil undersized, dirty coil (interior), dirty coil (exterior), etc., and may be displayed adjacent to text defining how to resolve the root cause to stop the fault from occurring or how to otherwise resolve the fault. The data processing system may identify the recommendations for each of the potential root causes and retrieve them from memory for display on the user interface. In some embodiments, the data processing system may display the recommendations for individual root causes upon receiving a selection selecting the root cause from a user. Upon receiving the selection, at a step 904, the data processing system may cause each of the recommendations that correspond to the selected root cause to appear on the user interface.

At a step 906, the data processing system may receive an input indicating a level of accuracy of the recommendation. For example, when the data processing system displays recommendations for resolving a particular root cause of a fault, the data processing system may also display levels of accuracy indicating whether the recommendation resolved the fault. Such levels of accuracy may include “not tried,” “tried,” “solved issue,” “partially solved the issue,” “made the issue worse,” a numerical rating, etc. After the predicted root cause occurs, an operator may follow the different recommendations to attempt to resolve the fault and then select the different options for the different recommendations to indicate the operator's level of success in resolving the fault.

At a step 908, the data processing system may determine a difference between the prediction and the expected prediction. The data processing system may do so based on the input level of accuracy. For example, after the data processing system outputs the potential root cause for a predicted fault and receives an input indicating the accuracy of a recommendation to resolve the predicted root cause, the data processing system may compare the indicated accuracy to the predicted accuracy for the root cause and determine a difference based on the comparison. The two sets of data may correspond to each other because, if the recommendation was successful, the root cause machine learning model may have predicted the correct root cause, but if the recommendation was unsuccessful, the root cause machine learning model may have predicted the incorrect root cause.

At a step 910, the data processing system may train the root cause machine learning model that predicted the root cause based on the determined difference. The data processing system may use the determined difference with a loss function and use back-propagation techniques to determine a gradient for the loss function. The data processing system may update the weights and/or parameters of the root cause machine learning model using the gradient, such as by using gradient descent techniques. Thus, the data processing system may train the root cause machine learning model using real-world training data without having to label the training data beforehand. Such training may be beneficial in systems in which pre-labeled training data is not available or is scarce, which may be common when training a machine learning model to evaluate data that is specific to a specific piece of building equipment.

In some embodiments, upon being trained, the data processing system may determine an accuracy for the root cause machine learning model's prediction by feeding the root cause machine learning model a training set of measurement data and receiving inputs indicating levels of accuracy of the root cause machine learning model's predictions. The data processing system may determine the accuracy of the root cause machine learning model's prediction by comparing the output predicted root causes to the user's inputs. The data processing system may compare the accuracy to a threshold to determine whether the root cause machine learning has been trained to an accuracy above the threshold. The data processing system may iteratively feed the root cause machine learning model training data until determining the model is accurate to the threshold, at which point the data processing system may use the root cause machine learning model in real-time to predict root causes for predicted faults in the piece of building equipment.

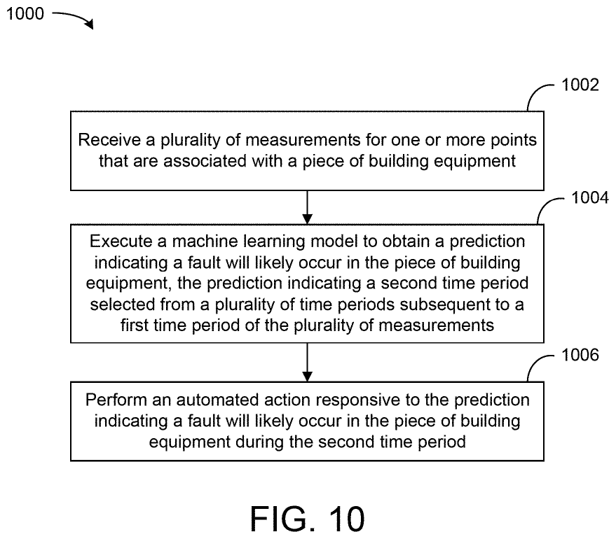

Referring now to FIG. 10, another flow diagram of a process 1000 for predicting a time period in which a fault is likely to occur using machine learning is shown, according to some embodiments. Process 1000 may be performed by a data processing system (e.g., fault prediction system 602). Process 1000 may include any number of steps and the steps may be performed in any order. The data processing system may perform process 1000 to automatically predict whether a fault will occur in a piece of building equipment in the future and perform an action based on the prediction. Thus, by performing process 1000, the data processing system may stop a piece of building equipment from experiencing a fault before the fault occurs, which may substantially minimize any energy loss or equipment malfunction that may have occurred if the fault were not stopped.

At an operation 1002, the data processing system may receive a plurality of measurements for one or more points that are associated with a piece of building equipment. The data processing system may receive the measurements from sensors that are associated with the piece of building equipment or the measurements may be stored values of setpoints that are associated with the piece of building equipment. The data processing system may retrieve the measurements from memory and generate a feature vector with the values.

At an operation 1004, the data processing system may execute a machine learning model to obtain a prediction indicating a fault will likely occur in the piece of building equipment. The data processing system may execute the fault prediction machine learning model using the generated feature vector with the measurement data to obtain an output of one or more confidence scores for different time periods. The data processing system may select the time period from the one or more time periods based on predetermined criteria. For example, the data processing system may evaluate confidence scores for different time periods that are output by the fault prediction machine learning model against a predetermined criteria. If the data processing system determines the confidence score of a time period satisfies the predetermined criteria, the data processing system may select the time period as the time period in which a fault will likely occur in the piece of building equipment. Accordingly, the data processing system may use measurements of points that are associated with a piece of building equipment from a first time period to predict that a fault will likely occur in the piece of building equipment during a specific time period after the first period.

At an operation 1006, the data processing system may perform an automated action responsive to the prediction indicating a fault will likely occur in the piece of building equipment during the selected time period. As described above, the automated action may be generating a record indicating a fault will likely occur and/or a recommendation to resolve the predicted fault, adjusting the configuration of the piece of building equipment to avoid the fault (e.g., change the configuration to a low power mode), adjusting the configurations of other pieces of building equipment so the piece of building equipment has to do less work (e.g., if the piece of building equipment is an AHU, the data processing system may increase the fan speed of other AHUs and decrease the fan speed of the AHU), displaying an alert at a client device indicating a fault will occur and/or the time period in which the fault will likely occur, etc. The data processing system may perform any action responsive to determining a fault will likely occur in the piece of building equipment. Thus, by performing such actions, the data processing system may operate to stop the piece of building equipment from experiencing a fault before the fault occurs.

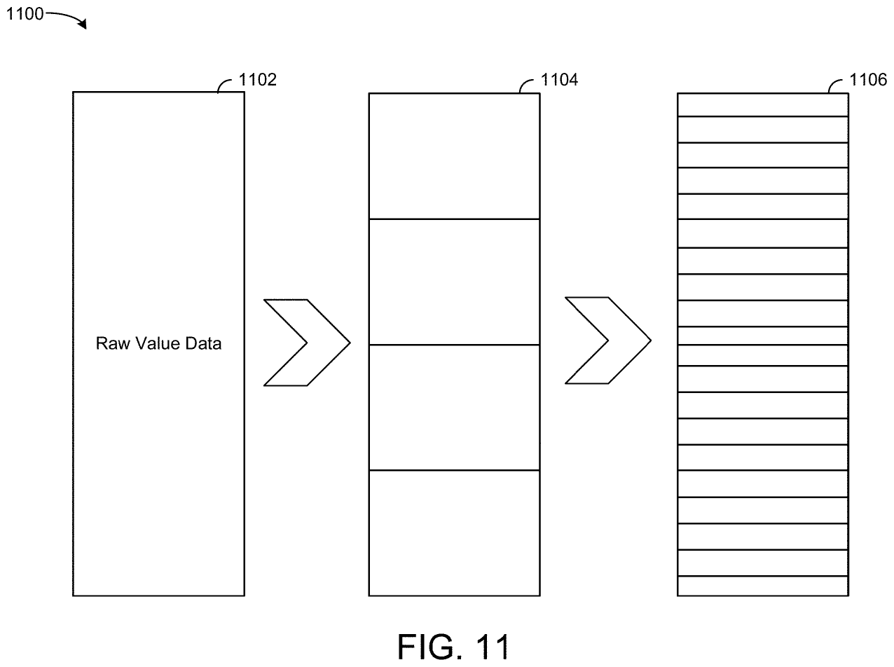

Referring now to FIG. 11, a block diagram illustrating a process 1100 for organizing raw data values into time bins is shown, according to some embodiments. In process 1100, a data processing system (e.g., fault prediction system 602) may generate a feature vector from collected raw value data 1102. The data processing system may generate the feature vector using raw value data 1102 to generate training data to train a machine learning model to predict time periods in which a fault is likely to occur in a piece of building equipment.

For example, when a fault occurs in a piece of building equipment, the data processing system may query a value service to retrieve timeseries values for points associated with the piece of building equipment from a database to obtain raw value data 1102. The data processing system may separate the values into discrete time bins 1104 (e.g., one bin per five-hour period) such as by labeling values with their corresponding time bins or creating a feature vector with index values of the vector that correspond to the different time bins. The time bins can be any time period and can be any length. The data processing system may reduce values of time bins 1104 into smaller segments (e.g., time segments or sub-time bins) by calculating the mean values for each time bin (e.g., subsampled at one-hour or any other time intervals). After reducing the data into time segments, the data processing system may label the values with an identification of the bin into which they have been placed to create a feature vector containing the labeled values. The data processing system may input the feature vector into a machine learning model to predict a time period in which a fault is likely to occur and/or a machine learning model to predict a root cause of the predicted fault. By using time bins and sub-time bins to create the feature vector, the data processing system may be able to create feature vectors of points with timestamps that do not exactly match and with timestamps that may vary (e.g., such as by using values that are generated or collected from sensors at different intervals).

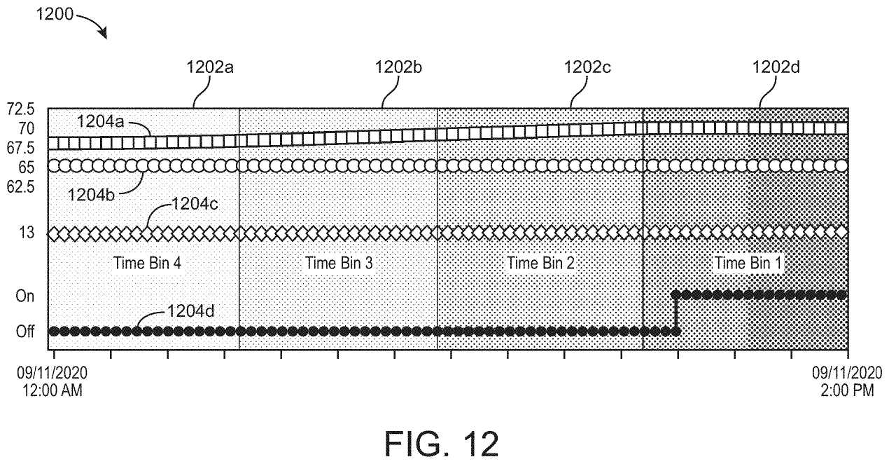

Referring now to FIG. 12, an illustration 1200 showing data values organized into multiple time bins is shown, according to some embodiments. Illustration 1200 may include values for time bins 1202a, 1202b, 1202c, and/or 1202d (collectively, time bins 1202) that each represent a different time period from which data was collected or with which the data is otherwise associated. Illustration 1200 may also include timeseries values 1204a, 1204b, 1204c, and/or 1204d, that are each associated with a different point of a piece of building equipment. As described above, a data processing system (e.g., fault prediction system 602) may generate a feature vector to input into one or more machine learning models to predict whether and/or when a fault will occur in a time period subsequent to the times associated with time bins 1202.

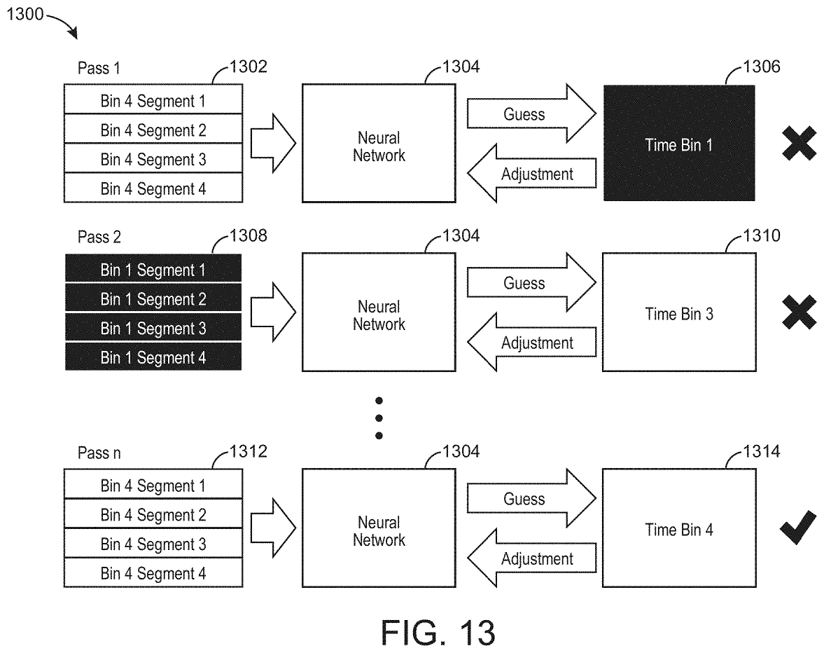

Referring now to FIG. 13, a block diagram illustrating a process 1300 for training a neural network is shown, according to some embodiments. A data processing system (e.g., fault prediction system 602) may implement process 1300 to train a machine learning model to predict a time period in which a fault is likely to occur. The data processing system may input a labeled feature vector 1302 into a neural network 1304. Labeled feature vector 1302 may include collected data and labels indicating the correct prediction for the collected data. For example, labeled feature vector 1302 may include values for sub-time bins and a label indicating the correct time bin to predict is “time bin four” (which may correspond to any specified time period in the future). Data processing system may feed labeled feature vector 1302 into neural network 1304, which may process labeled feature vector 1302 and output a prediction 1306 of “time bin one.” The data processing system may compare the output prediction 1306 with the labeled prediction and adjust the weights and parameters of neural network 1304 using back-propagation techniques according to a difference (e.g., a difference between confidence scores) between the prediction and the label.

In a second pass, the data processing system may generate a labeled feature vector 1308 that is similar to labeled feature vector 1302 but may include different values, a different label, and/or be associated with values from a different time period. The data processing system may feed labeled feature vector 1308 into neural network 1304, which may process labeled feature vector 1308 based on its adjusted weights, and output a prediction 1310 of “time bin three.” The data processing system may compare output prediction 1310 with the label of labeled feature vector 1308 and adjust the weights and parameters of neural network 1304 using back-propagation techniques according to a difference between the prediction and the label.

In a third pass, the data processing system may generate a labeled feature vector 1312 that may be similar to labeled feature vector 1302 and/or 1308, but may include different values, a different label, and/or be associated with values from a different time period. The data processing system may feed labeled feature vector 1312 into neural network 1304, which may process labeled feature vector 1312 based on its adjusted weights and output a prediction 1314 of “time bin four.” The data processing system may compare the output prediction 1314 with the label of feature vector 1312 and adjust the weights and parameters of neural network 1304 using back-propagation techniques according to a difference between the prediction and the label. The data processing system may repeat the process with any number of feature vectors to train the fault prediction machine learning model to predict time periods in which faults are likely to occur for the piece of building equipment. The data processing may repeat the training process until determining neural network 1304 is accurate above a threshold at predicting time periods in which a fault is likely to occur. At which point, the data processing system may use the fault prediction machine learning model to predict faults for a piece of building equipment in real-time to avoid the ramifications of the predicted fault.

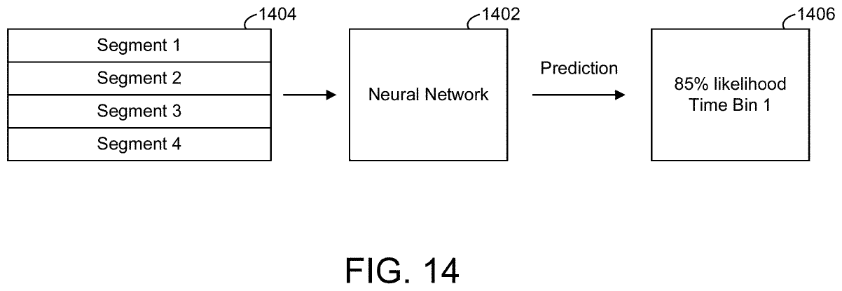

Referring now to FIG. 14, a block diagram illustrating a neural network 1402 predicting a time period in which a fault is likely to occur is shown, according to some embodiments. A data processing system (e.g., fault prediction system 602) may execute neural network 1402 by applying a feature vector 1404, which may be generated using collected values as described above, to neural network 1402 as input. Upon execution, the fault prediction machine learning model may output a prediction 1406 including a time period in which a fault is likely to occur and/or a confidence score indicating the confidence the fault prediction machine learning model has in the prediction. The data processing system may obtain the confidence score and the predicted time bin and determine a recommendation for stopping the fault from occurring by either using a rule-based system or by using another machine learning model with the values of the feature vector as input as described herein. For example, if the data processing system determines there is a high likelihood that a fault will occur in the next four days, the data processing system may adjust the maintenance schedule to prevent the fault from occurring. Thus, by using the trained neural network to predict when a fault will occur, the data processing system may avoid faults from occurring.

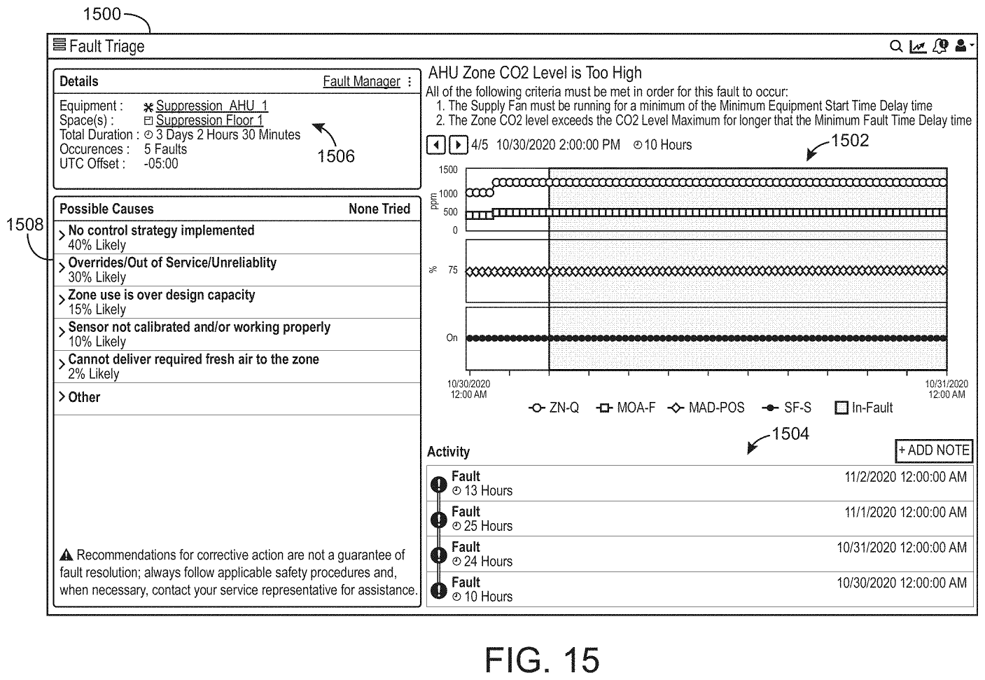

Referring now to FIG. 15, a user interface 1500 depicting root cause predictions for faults is shown, according to some embodiments. User interface 1500 may illustrate indications that a fault has occurred in a piece of building equipment and possible causes for the fault. A client device may access and/or present user interface 1500 responsive to a user selection of an application and/or responsive to detecting the fault occurred. User interface 1500 may be generated by a data processing system (e.g., fault prediction system 602).

User interface 1500 may include a set of values 1502, an activity timeline 1504, a fault description 1506, and/or a possible cause set 1508. Set of values 1502 may include timeseries values of one or more points that are associated with a piece of building equipment. The values may be collected measurements from sensors that are associated with the piece of building equipment and/or setpoints associated with the piece of building equipment. For example, as illustrated, set of values 1502 may include values for current fan status and/or current carbon dioxide levels of a space throughout a day. Set of values 1502 may include any values for any time period. In some embodiments, set of values 1502 may include values based on which a machine learning model has predicted the fault for the piece of building equipment and/or the root cause of the fault. Thus, a user, such as an operator, may easily view the values that are associated with the fault in the piece of building equipment.

Activity timeline 1504 may show a timeline of faults that have occurred in the piece of building equipment. Activity timeline 1504 may include times and/or dates in which faults occurred, lengths of time each fault lasted, and/or, in some cases, descriptions of the faults. Activity timeline 1504 may include any data relating to faults. In some embodiments, a user may select any of the predicted faults to view more data about the fault (e.g., the values that indicated the fault, the amount of excess energy that was used as a result of the fault, etc.). Activity timeline 1504 may enable a user to view the number of faults a piece of building equipment experienced and various analytics about each fault.

Fault description 1506 may include an identification of the equipment that experienced the fault, a space in which the piece of building equipment is located, a duration of the fault, and/or a number of instances in which the fault was detected within a time period. Fault description 1506 may include any amount of data about a detected fault.

Possible cause set 1508 may include a list of possible root causes of the detected fault. Possible cause set 1508 may include a list of possible causes of a detected fault. In some embodiments, possible cause set 1508 may include percentages that the possible causes are correct. In some embodiments, the percentages may be confidence scores predicted by a machine learning model that indicate the level of confidence that the root cause machine learning model has that the root cause is the correct prediction as the cause of the fault. A user may view possible cause set 1508 to see various possible reasons that a fault occurred and attempt to resolve the fault based on the possible causes.

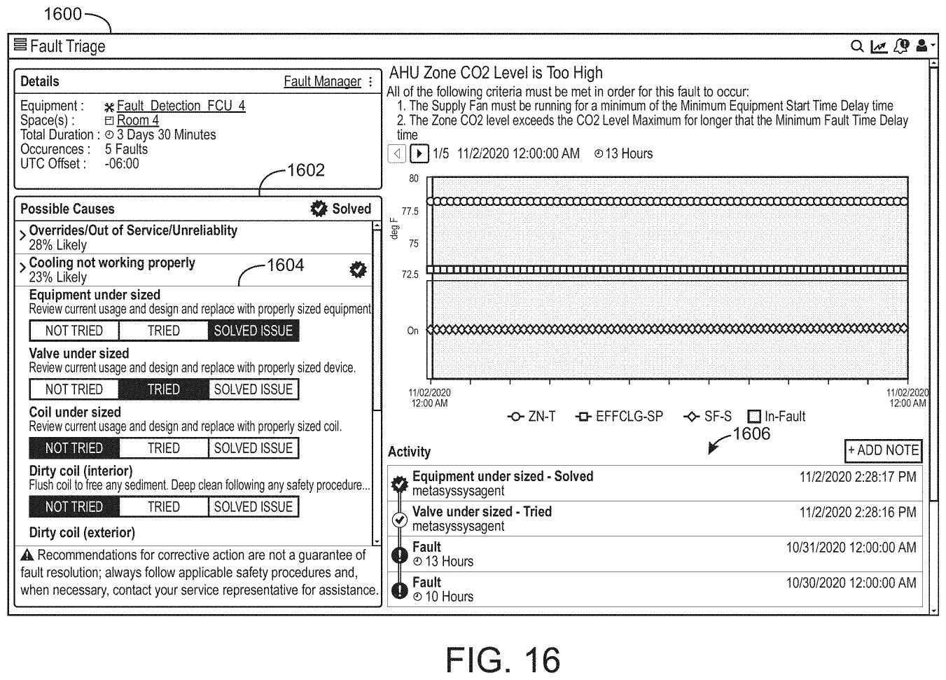

Referring now to FIG. 16, a user interface 1600 depicting root cause predictions for faults is shown, according to some embodiments. A data processing system (e.g., fault prediction system 602) may generate user interface 1600 upon receiving a user input at a possible cause set 1602, which may be the same or similar to possible cause set 1508. As illustrated, a user may select one of the predicted root causes of possible cause set 1602 to cause a dropdown of recommendations 1604 for resolving a fault to appear on the user interface. Each recommendation of dropdown of recommendations 1604 may correspond to the predicted root cause and may be input by an administrator (e.g., a domain expert). A user may select any of the predicted root causes of the fault from user interface 1600.

Dropdown of recommendations 1604 may display different levels of accuracy for each recommendation of dropdown of recommendations 1604. As described above, a user may select any of the different levels of accuracy after the user has attempted to resolve the fault using the corresponding recommendation and the data processing system may train a machine learning model that predicted the corresponding root cause (e.g., a confidence score for the root cause) based on the user's selection.

User interface 1600 may also include an activity timeline 1606. Activity timeline 1606 may be similar to 1604, shown and described with reference to FIG. 15. Additionally, activity timeline 1606 may show the levels of accuracy that a user has selected for different recommendations and the times in which the selections were made to maintain a running list of the user's attempts to resolve the fault and how successful each attempt was. The user may view the running list to keep track of the different actions the user has taken to resolve the fault.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method, comprising:
receiving, by one or more processors, a plurality of measurements for one or more points that are associated with a piece of building equipment, the plurality of measurements measured during a first time period;
executing, by the one or more processors, a machine learning model using the plurality of measurements as an input to generate fault data for a plurality of time periods subsequent to the first time period;
selecting, by the one or more processors, a second time period from the plurality of time periods responsive to an assessment of the fault data for the plurality of time periods indicating a fault will likely occur in the piece of building equipment during the second time period of the plurality of time periods; and
performing, by the one or more processors, an automated action responsive to the selection of the second time period.

2. The method of claim 1, wherein executing the machine learning model using the plurality of measurements further comprises:
executing, by the one or more processors, the machine learning model using the plurality of measurements to obtain a plurality of confidence scores for the plurality of time periods; and
wherein selecting the second time period from the plurality of time periods is performed responsive to determining that the second time period is associated with a confidence score that satisfies a predetermined criteria.

3. The method of claim 2, wherein determining the second time period is associated with a confidence score that satisfies a predetermined criteria comprises determining, by the one or more processors, that the confidence score exceeds a threshold.

4. The method of claim 1, wherein the machine learning model is a first machine learning model, and further comprising:
responsive to the selection of the second time period, executing, by the one or more processors, a second machine learning model using the plurality of measurements to obtain an output indicating a predicted root cause of the predicted fault in the piece of building equipment;
wherein performing the automated action comprises generating, by the one or more processors, a record comprising a recommendation for resolving the predicted fault based on the predicted root cause.

5. The method of claim 4, wherein executing the second machine learning model using the plurality of measurements further comprises executing, by the one or more processors, the second machine learning model using an identification of the second time period.

6. The method of claim 4, further comprising:
presenting, by the one or more processors, the recommendation on a user interface;
receiving, by the one or more processors via the user interface, an input indicating a level of accuracy of the recommendation; and
training, by the one or more processors, the second machine learning model based on the predicted root cause and the input level of accuracy.

7. The method of claim 4, wherein executing the second machine learning model using the plurality of measurements to obtain the output indicating the root cause further comprises executing, by the one or more processors, the second machine learning model using the plurality of measurements to obtain a plurality of confidence scores for a plurality of root causes for the predicted fault, the method further comprising:
presenting, by the one or more processors on a user interface, the plurality of confidence scores for the plurality of root causes;
receiving, by the one or more processors via the user interface, a plurality of inputs indicating levels of accuracy of the plurality of confidence scores; and
training, by the one or more processors, the second machine learning model based on the plurality of root causes and the plurality of inputs.

8. The method of claim 1, further comprising:
storing, by the one or more processors, an association between the machine learning model and the piece of building equipment,
wherein performing the automated action comprises:
identifying, by the one or more processors, an identification of the piece of building equipment based on the stored association between the machine learning model and the piece of building equipment; and
generating, by the one or more processors, a record comprising an identification of the piece of building equipment.

9. The method of claim 1, further comprising:
storing, by the one or more processors, an association between the machine learning and the piece of building equipment;
retrieving, by the one or more processors, measurement data based on the stored association; and
training, by the one or more processors, the machine learning model based on the retrieved measurement data.

10. The method of claim 1, further comprising:
grouping, by the one or more processors, the plurality of measurements into a plurality of time bins based on timestamps associated with the plurality of measurements, each time bin of the plurality of time bins associated with a different time window; and
generating, by the one or more processors, a feature vector using the grouped plurality of measurements by labeling the plurality of measurements with labels identifying the time bins into which each of the plurality of measurements has been grouped,
wherein executing the machine learning model using the plurality of measurements further comprises applying, by the one or more processors, the feature vector as an input into the machine learning model.

11. The method of claim 10, wherein grouping the plurality of measurements into the plurality of time bins further comprises:
grouping, by the one or more processors, measurements of individual time bins of the plurality of time bins into a plurality of sub-time bins; and
determining, by the one or more processors, averages of measurements of individual sub-time bins of the plurality of sub-time bins,
wherein generating the feature vector using the received measurements further comprises generating, by the one or more processors, the feature vector using the determined averages and labeling, by the one or more processors, the determined averages with labels identifying the individual sub-time bins of the determined averages.

12. The method of claim 1, further comprising:
identifying, by the one or more processors, one or more setpoints for the one or more points, the one or more setpoints configured for times within the first time period;
wherein executing the machine learning model using the plurality of measurements further comprises executing, by the one or more processors, the machine learning model using the one or more setpoints.

13. A system comprising one or more memory devices configured to store instructions thereon that, when executed by one or more processors, cause the one or more processors to:
receive a plurality of measurements for one or more points that are associated with a piece of building equipment, the plurality of measurements measured during a first time period;
execute a machine learning model using the plurality of measurements as an input to generate fault data for a plurality of time periods subsequent to the first time period;
select a second time period from the plurality of time periods responsive to an assessment of the fault data for the plurality of time periods indicating a fault will likely occur in the piece of building equipment during the second time period of the plurality of time periods; and
perform an automated action responsive to the selection of the second time period.

14. The system of claim 13, wherein the instructions cause the one or more processors to execute the machine learning model using the plurality of measurements further by causing the one or more processors to:
execute the machine learning model using the plurality of measurements to obtain a plurality of confidence scores for the plurality of time periods; and
select the second time period from the plurality of time periods responsive to determining the second time period is associated with a confidence score that satisfies a predetermined criteria.

15. The system of claim 14, wherein the instructions cause the one or more processors to determine the second time period is associated with a confidence score that satisfies a predetermined criteria by causing the one or more processors to determine that the confidence score exceeds a threshold.

16. The system of claim 13, wherein the machine learning model is a first machine learning model, and wherein the instructions further cause the one or more processors to:
responsive to the prediction indicating a fault will likely occur during the second time period, execute a second machine learning model using the plurality of measurements to obtain an output indicating a predicted root cause of the predicted fault in the piece of building equipment;
wherein the instructions cause the one or more processors to perform the automated action by causing the one or more processors to generate a record comprising a recommendation for resolving the predicted fault based on the predicted root cause.

17. The system of claim 16, wherein the instructions cause the one or more processors to execute the second machine learning model using the plurality of measurements by causing the one or more processors to execute the second machine learning model using an identification of the second time period.

18. The system of claim 16, wherein the instructions further cause the one or more processors to:
present the recommendation on a user interface;
receive, via the user interface, an input indicating a level of accuracy of the recommendation; and
train the second machine learning model based on the predicted root cause and the input level of accuracy.

19. A method, comprising:
receiving, by one or more processors, a plurality of measurements for one or more points that are associated with a piece of building equipment, the plurality of measurements measured during a first time period;
executing, by the one or more processors, a first machine learning model using the plurality of measurements to obtain an output predicting a fault will occur in the piece of building equipment within a second time period subsequent to the first time period;
responsive to the prediction that a fault will occur in the piece of building equipment within the second time period, executing, by the one or more processors, a second machine learning model using the plurality of measurements and an identification of the second time period to obtain an output indicating a predicted root cause of the predicted fault in the piece of building equipment; and
performing, by the one or more processors, an automated action responsive to the predicted root cause of the predicted fault in the piece of building equipment.

20. The method of claim 19, wherein performing the automated action comprises generating, by the one or more processors, a record comprising a recommendation for resolving the predicted fault based on the predicted root cause, further comprising:
presenting, by the one or more processors, the recommendation on a user interface;
receiving, by the one or more processors via the user interface, an input indicating a level of accuracy of the recommendation; and
training, by the one or more processors, the second machine learning model based on the predicted root cause and the input level of accuracy.
